(19) United States
(12) Patent Application Publication
(10) Pub. No.: US 2008/0199287 A1
(43) Pub. Date: Aug. 21, 2008

(54) STORAGE AND/OR TRANSPORT CONTAINER FOR BULK MATERIAL, ESPECIALLY PUSH-BOTTOM BUNKER

(76) Inventor: Christoph MARTENS, Rockstedt (DE)

Correspondence Address: MCGLEW & TUTTLE, PC, P.O. BOX 9227, SCARBOROUGH STATION, SCARBOROUGH, NY, 10510-9227, US

(21) Appl. No.: 11/675,834

(22) Filed: Feb. 16, 2007

(51) Int. Cl. B65G 1/00

(52) U.S. Cl. 414/325

(57) ABSTRACT

A storage and/or transport container for bulk material is provided with a bottom and a first discharge device (16, 17) for discharging bulk material from the container. The first discharge device (16, 17) is arranged on the bottom. An additional discharge device (24, 26) has a conveying direction extending at right angles to a discharge direction of said first discharge device (16, 17) and is arranged at least partially above the bottom. The additional discharge device may be a screw conveyor and the first discharge device may be a push-bottom with two pushing elements (16, 17) with a separate drive (23) associated with each pushing element (16, 17).

### FIELD OF THE INVENTION

The present invention pertains to a storage and/or transport container for bulk material, especially a push-bottom bunker with a bottom, a first discharge means for the bulk material, which is arranged on or adjacent to the container bottom and with an additional discharge means with a conveying direction extending at right angles to the first discharge means.

### BACKGROUND OF THE INVENTION

Such a storage and/or transport container for bulk material, namely, a push-bottom bunker, is known from EP 0 317 142 A1.

Push-bottom bunkers are frequently used as temporary storage containers for bulk material. However, they are not, of course, limited to this application. They can rather also be advantageously used as transport containers, for example, as agricultural trailers for silage fodder, as interchangeable containers similar to a container or as stationary storage containers for all types of bulk materials, especially (grass) silage fodder or solid manure. Push-bottom bunkers have the property of dispensing bulk material uniformly or in suitable quantities and at suitable time intervals. For example, push-bottom bunkers may be used in conjunction with biogas units, incinerator units, composting units or agricultural facilities (fodder silos). Their task is to feed the bulk material being stored in them to the subsequent use, for example, to a biogas fermenter, uniformly in a suitable dosage or in a suitable quantity and at suitable time intervals without frequent refilling of the bulk material.

The push-bottom bunker shown in EP 0 317 142 A1 has two ladder-like pushing elements, which are arranged one on top of another and are movable relative to one another. Two pressurizing agent cylinders are associated with each pushing element. These pressurizing agent cylinders are actuated such that they are moved to and fro in opposite directions relative to one another. This motion entails the risk that the bulk material will “build up” and the conveying process will come to a standstill in case of intensely fraying or felting bulk material.

A push-bottom bunker, in which the pushing bottom comprises a plurality of bottom panels, which extend in the longitudinal direction of the push-bottom bunker and are located next to each other, is known from DE 44 44 277 A1. The bottom panels have a flat surface and are movable to and fro in the push-out direction, i.e., in their longitudinal direction. The bottom panels are connected in groups with one another and all panels are moved at first in the direction of the push-out opening and a first group of bottom panels is then first moved back and the other group of bottom panels is finally moved back. The bulk material shall remain in place during the backward motion because of the lower resistance of the individual bottom panels or panel groups. This principle is also called “walking floor.”

DE 40 08 287 A1 shows a push-bottom bunker with two ladder-like pushing elements, which are located next to each other and are driven by a hydraulic cylinder each. The pushing elements or their rungs cooperate with rungs mounted on the bottom in a fixed manner. The mobile conveying elements are moved alternatingly to and fro by means of the hydraulic cylinders. The cycles of motion of the left-hand pushing element and of the right-hand pushing element in relation to one another do not appear from the document. Controlling of the hydraulic cylinders independently from one another is also not disclosed in the document.

It is also known that ladder-like elements located next to each other can be used instead of the panels with a flat surface. Rungs of these elements are shaped such that they have a high resistance for the bulk material in the push-out direction and thus push out the bulk material. They have only a low resistance in the opposite direction, so that the bulk material can slide over them. The drawback of these panels located next to each other is that the bulk material is transported only by virtue of friction. Intensely fraying/entwined bulk materials, for example, grass silage or solid manure, may cause the conveying capacity to decrease greatly, for example, because of bridge formation, or for the conveying to come to a standstill altogether.

It is known in self-loading carts for grass (silage carts) used in agriculture that a circulating chain each is arranged at the bottom of the hay cart at both longitudinal edges of the forage cart, the chains being connected to one another by crossrails. The load strand is moved over the bottom of the hay cart and the return strand (return motion) is led through under the bottom. As a result, the lower layer of hay is always, as it were, peeled off from the hay cart. This process works rather well as long as the hay is fresh and dry.

### SUMMARY OF THE INVENTION

According to the invention, a storage and/or transport container for bulk material is provided, especially a push-bottom bunker (pushing floor container), with a bottom, a first discharge means arranged on the bottom for the bulk material, and with another discharge means with a conveying means extending at right angles to the first discharge means.

Screw conveyors are used mostly in practice as other discharge means. These screw conveyors are arranged under the bottom in prior-art push-bottom bunkers (pushing floor container). This is especially disadvantageous in case of grass silage as a bulk material, because bridge formation above the screw conveyor may lead to clogging. This is also enhanced by the fact that the bulk material cannot be conveyed with external force against the screw conveyor, but it must rather drop under its own weight between the helices of the screw conveyor. This leads to problems not only in case of grass silage, but with lightweight bulk materials as well. Bulk material that is already on the screw cannot be retracted by means of the push bottom. Overload of the screw conveyor also cannot be counteracted immediately, but overload leads at first to the failure of the unit and the bulk material must be removed from the screw conveyor in another way. In summary, the drawback of the state of the art is consequently that there is a risk of clogging of the discharge system in the area of the screw conveyor.

To avoid this, the storage and/or transport container is characterized according to this aspect of the present invention in that the additional discharge means is arranged at least partially above the bottom.

Clogging-free conveying of the bulk material is surprisingly guaranteed in a simple manner by the design according to the present invention. Since the additional discharge means, generally a screw conveyor, is arranged at least partially above the bottom, i.e., in the plane of the first discharge means, which is, in general, a push bottom, and the bulk material is pressed by means of the push bottom against the screw and hence also between the helices of the screw conveyor. In case of intensely felting bulk materials, for example, grass silage, this also causes bridges to be torn apart. Consequently, separate spiked rollers are not necessary any longer. The weight of the bulk material is not important any longer, either. This also leads to a relief of the electric drives. Should clogging nevertheless occur in the area of the screw conveyor, the screw conveyor can be cleaned again by reversing the direction of conveying of the screw conveyor and the push bottom. This happens especially when the screw conveyor is arranged entirely above the bottom.

The storage and/or transport container according to the present invention may also have the push drive with plural push elements wherein the drive of one of the pushing elements can be actuated independently from the drive of one of the other pushing elements.

Provisions may be made for the drive of one pushing element to be able to be actuated independently from the drive of the other pushing element. It is accordingly possible to carry out freely programmable, different motion cycles. The rhythm of the motions of the two pushing elements can also always be varied. Should nevertheless a bridge unexpectedly form in the bulk material, this can also be disintegrated by a suitable motion. In particular, a motion cycle takes place such that the two pushing elements are moved at first synchronously in the direction of the charging opening, after which one pushing element is first returned into the starting position and the other pushing element is likewise moved back into its starting position only thereafter. As was stated, this motion cycle is suitable for trouble-free discharge. Deviations herefrom are possible on a case-by-case basis. At any rate, the measure according to the present invention ensures that the formation of bridges is prevented from occurring as best as possible. Bridges that are nevertheless formed can be rapidly disintegrated by suitable actuation of the drives in a simple manner.

According to a design variant of the present invention, the drive for each pushing element is arranged outside the container, so that it is protected from being contaminated by the bulk material.

The pushing elements are preferably designed such that each pushing element has at least one push rod, especially two push rods, on each longitudinal side of the container, and rungs extending at right angles to the push-out direction. The rungs of one pushing element should be arranged offset in relation to the rungs of the other pushing element, as a result of which bridges that may be formed in the bulk material can be broken up especially effectively. One pushing element can lie directly on the bottom of the container, while the other pushing element is located at a distance corresponding to the height of the first pushing element, i.e., it lies on the first pushing element.

To achieve good loosening of fraying/entwined bulk material or to break up bridges, it is advantageous if the rungs of one pushing element, on the one hand, and the rungs of the other pushing element, on the other hand, are moved relative to one another over a range of the motion cycle during a motion cycle. This is preferably achieved such that even though the pushing elements are moved together in the direction of the push-out opening, only one pushing element is moved back at first and the other pushing element is moved back subsequently during the phase of stopping of that pushing element.

To prevent bridges from forming in case of intensely fraying/entwined bulk material even more and to break up bridges being formed, provisions are made according to a variant for the rungs to be equipped with knives, which cut up the bulk material during the motion of the pushing element, especially against the push-out direction.

Within the framework of the present invention, the pushing means does not need to be provided with pushing elements that extend over the entire width of the container. It may be meaningful, especially in case of very broad containers (measured at right angles to the push-out direction) to use a plurality of openings of pushing means arranged one on top of another, which said openings are located next to each other.

The present invention will be explained in more detail below on the basis of exemplary embodiments shown in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a vertical sectional view of a first exemplary embodiment of a container;

FIG. 2 is a top view of the container according to FIG. 1;

FIG. 3 a top view showing a pushing element for a container according to FIG. 1;

FIG. 4 is a top view of a second exemplary embodiment;

FIG. 5 is a top view of a third exemplary embodiment;

FIG. 6 is a vertical sectional view of the container according to FIG. 5; and

FIG. 7 is a vertical sectional view of another exemplary embodiment of a container having the features of the present invention.

### DESCRIPTION OF THE PREFERRED EMBODIMENTS

Referring to the drawings in particular, the containers shown in FIGS. 1 through 6 are so-called push-bottom bunkers 10. They may be used stationarily for storing bulk material, for example, garden wastes, household refuse or silage fodder from agricultural facilities, which are fed to a fermenter or to an incinerator in a metered manner, or as transport containers on (trailer) chassis.

The push-bottom bunker 10 has a rear wall 11, a front wall 12, in which there is a push-out opening 13, side walls 14 and a bottom 15. The push-bottom bunker 10 is open upwardly for being filled, but it may optionally also be provided with a cover.

Two pushing elements 16, 17, which are arranged one on top of another, are arranged on the bottom 15. The pushing elements 16, 17 are movable to and fro in the direction of the push-out opening 13, i.e., in the push-out direction and away from that direction, the lower pushing element 17 sliding on the bottom 15 and the upper pushing element 16 on the lower pushing element 17.

FIG. 3 shows the lower pushing element 17 as an example. It has two push rods 18, which extend along the side walls 14 on both sides of the bottom 15 and which are connected to one another by “rungs” 19 extending at right angles to the push-out direction. As can be determined from FIG. 2, the rungs 19 slide directly over the bottom 15.

The upper pushing element 16 has a design analogous to that of the lower pushing element 17, namely, it is likewise equipped with push rods 20 and rungs 21. However, the rungs 21 are offset here downward via webs 22 in relation to the push rods 20, so that these are arranged in the same plane as the rungs 19 of the lower pushing element 17. Consequently, they likewise slide over the bottom 15 in this case. The rungs 19 and 21 are arranged, as can be recognized from FIGS. 1 and 2, between one another and equidistantly from one another.

As can be clearly recognized from FIG. 1, the rungs 19, 21 has an approximately triangular cross section, namely, with an upper side sloping away from the push-out opening 13. The approximately vertical front side thus offers good resistance to the bulk material for the pushing out of the bulk material during the forward motion of the pushing element 16, 17. When the pushing elements 16, 17 are retracted, the bulk material can slide readily past the rungs 19, 21, which now offer a low resistance to the bulk material, because of the sloping upper side.

Drives are provided for the pushing elements 16, 17 outside the push-bottom bunker 10, namely, behind the rear wall 11. The push rods 18, 20 are led to the outside for this purpose through openings in the rear wall 11 and are driven by means of pressurizing agent cylinders in such a way that they move to and fro. The pushing elements 23 are equipped with a separate drive of their own and can be actuated independently from one another. A motion cycle takes place, for example, as follows:

Both pushing elements 16 and 17 are moved first forward in the direction of the push-out opening 13. Only one of the two pushing elements, for example, the upper pushing element 16, is then retracted first, while the other pushing element 17 is still immobile. The other pushing element 17 is finally retracted, while the first pushing element 16 is immobile. The motion cycle now begins anew.

As an alternative, the pushing elements 16, 17 may also be moved together away from the push-out opening 13, after which one of the two pushing elements 16, 17 can be moved back first in the direction of the push-out opening 13 during the stopping of the respective other pushing element 16, 17.

Furthermore, the above-described motion cycles may also be combined with one another or motion cycles controlled freely, for example, randomly, may also be provided for.

In case of very intensely fraying/entwined bulk material, the rungs 19, 21 may also be additionally equipped with knives (not shown), whose cutting edges point rearwardly towards the rear wall. The bulk material is cut up as a result during the backward motion of the pushing elements 16, 17, whereas the knives even increase the resistance on the bulk material during the forward motion.

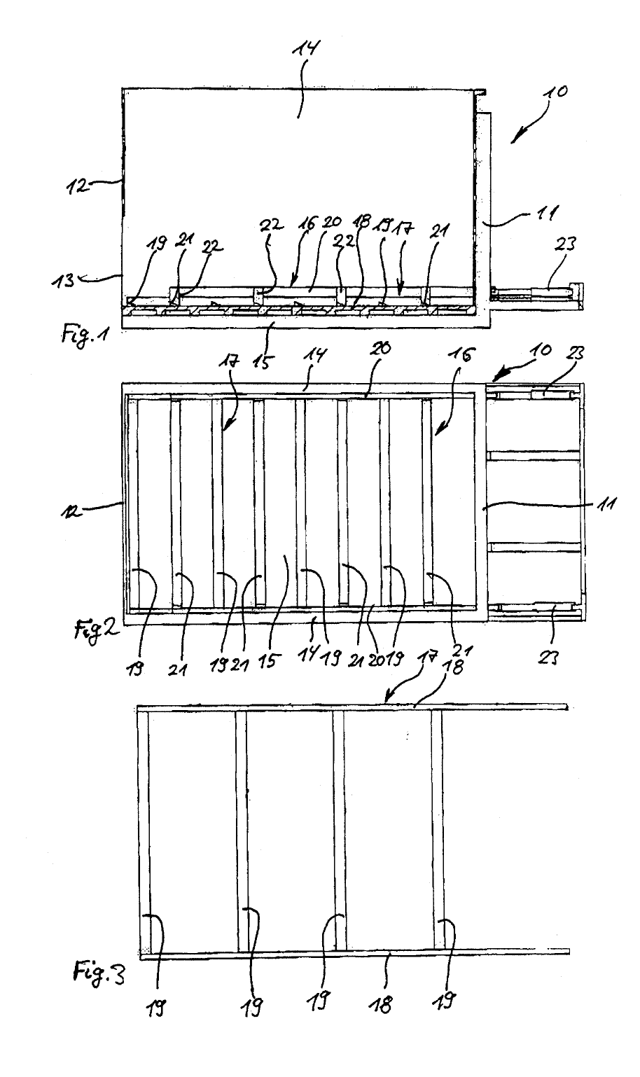

FIG. 4 shows an analogous push-bottom bunker 10, in which a screw 24 is also arranged in front of the push-out opening 13 to remove the bulk material pushed out. The screw 24 removes the bulk material to the side.

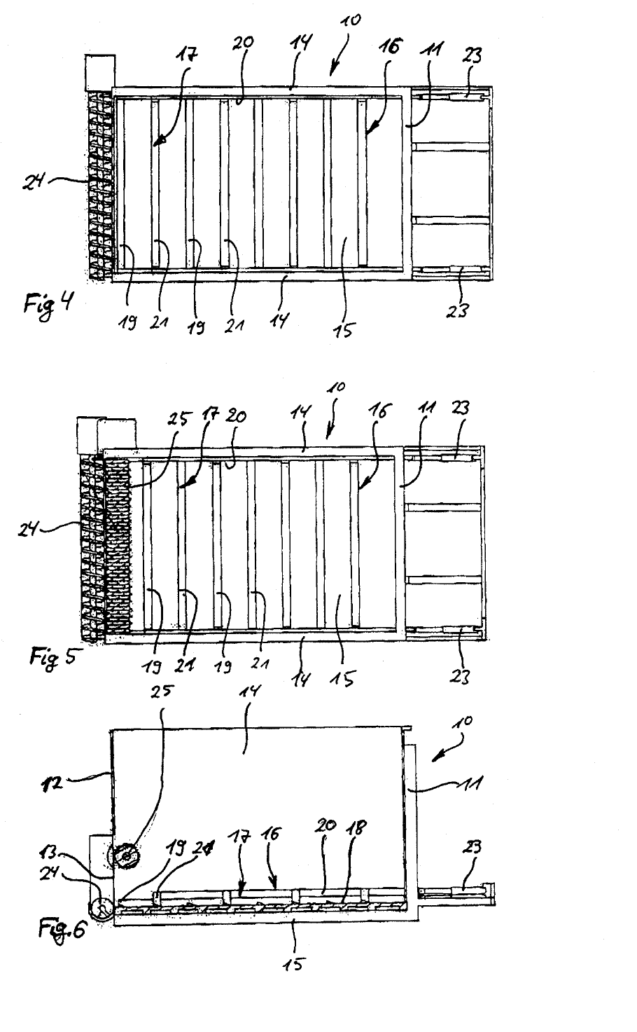

A spiked roller 25 is also provided for very intensely fraying/entwined bulk material in the exemplary embodiment according to FIGS. 5 and 6.

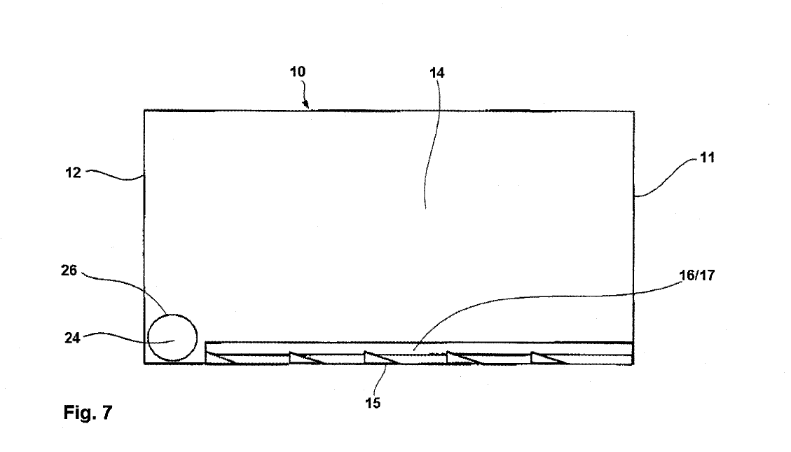

FIG. 7 shows a variant of the above-described push-bottom bunker 10, which can also be thought to be an independent variant. This push-bottom bunker 10 has a bottom 15, side walls 14, a rear wall 11 and a front wall 12. A so-called push bottom 16, 17 as in the embodiments of FIGS. 1 to 6, or a push bottom which is known from the state of the art, is arranged on the bottom 15. The push bottom 16, 17 discharges a bulk material filled into the push-bottom bunker 10 in the direction of the front wall 12 by moving to and fro on the bottom 15. In the embodiment of FIG. 7 the push bottom 16, 17 is made somewhat shorter than the bottom 15. A screw conveyor 24 with a direction of conveying extending at right angles to the direction of conveying of the push bottom 16, 17 is arranged in a free space between the push bottom 16, 17 and the front wall 12. This means that the longitudinal axis of the screw conveyor 24 is arranged at right angles to the direction of conveying of the push bottom 16, 17.

As can be clearly recognized from FIG. 7, the screw conveyor 24 is arranged entirely above the bottom 15. In other words, an imaginary generated surface 26 of the screw conveyor 24 does not undercut the bottom 15. It is rather arranged with a narrow gap above the bottom 15.

While specific embodiments of the invention have been shown and described in detail to illustrate the application of the principles of the invention, it will be understood that the invention may be embodied otherwise without departing from such principles.

What is claimed is:

1. A storage and/or transport container for bulk material, the container comprising:
a bottom;
a first discharge means for discharging bulk material from the container, said first discharge means being arranged on said bottom; and
an additional discharge means with a conveying direction extending at right angles to a discharge direction of said first discharge means, said additional discharge means being arranged at least partially above said bottom.

2. A container in accordance with claim 1, wherein said first discharge means is a push bottom.

3. A container in accordance with claim 1, wherein said additional discharge means is a screw conveyor.

4. A container in accordance with claim 3, wherein said screw conveyor has a longitudinal axis arranged above said bottom.

5. A container in accordance with claim 1, wherein a imaginary generated surface of said screw conveyor does not undercut said bottom.

6. A container according to claim 2, wherein said push-bottom includes pushing means for pushing the bulk material out of the container in the discharge direction, said pushing means comprising:
at least two pushing elements, which can be moved to and fro in said discharge direction as well as relative to one another,
a separate drive associated with each said pushing element, wherein said drive of one of said pushing elements can be actuated independently from said drive of one of said other pushing elements.

7. A container in accordance with claim 6, wherein said pushing elements are led out of the container and said separate drive associated with each said pushing element includes a drive for said pushing elements arranged outside the container.

8. A container in accordance with claim 6, wherein each of said pushing elements comprises:
a push rod on each longitudinal side of the container, and
rungs extending at right angles to the push-out direction, said rungs being arranged offset in relation to one another.

9. A container in accordance with claim 6, wherein said pushing elements are arranged one on top of another, such that one of said pushing elements lies on said bottom and said additional pushing element is located at a distance from said container bottom by the height of said first pushing element.

10. A container in accordance with claim 8, wherein said rungs of said first pushing element and said rungs of said additional pushing element are moved relative to one another over a range of a motion cycle.

11. A container in accordance with claim 6, wherein at least one of said pushing elements is equipped with knives, which cut the bulk material during the motion of said pushing element.

12. A container in accordance with claim 6, wherein said pushing means is formed from two or more openings of pushing elements arranged one on top of another, which said openings are arranged next to each other.

13. A storage and/or transport container for bulk material, the container comprising:
container walls and a bottom;
a push bottom for discharging bulk material from the container in a discharge direction, said push bottom including two pushing elements with at least one of said push elements arranged on said bottom; and
a screw conveyor extending at right angles to said discharge direction, said screw conveyor having a physical extent arranged spaced from said bottom.

14. A container in accordance with claim 13, wherein said screw conveyor has a longitudinal axis arranged above said bottom.

15. A container in accordance with claim 13, wherein a imaginary generated surface of said screw conveyor does not undercut said bottom.

16. A container according to claim 13, wherein said push-bottom includes pushing means for pushing the bulk material out of the container in the discharge direction, said pushing means comprising:
said two pushing elements, which can be moved to and fro in said discharge direction as well as relative to one another,
a separate drive associated with each said pushing element, wherein said drive of one of said pushing elements can be actuated independently from said drive of one of said other pushing elements.

17. A container in accordance with claim 16, wherein said pushing elements are led out of the container and said separate drive associated with each said pushing element includes a drive for said pushing elements arranged outside the container.

18. A container in accordance with claim 16, wherein each of said pushing elements comprises:
a push rod on each longitudinal side of the container, and
rungs extending at right angles to the push-out direction, said rungs being arranged offset in relation to one another.

19. A container in accordance with claim 16, wherein said pushing elements are arranged one on top of another, such that one of said pushing elements lies on said bottom and said additional pushing element is located at a distance from said container bottom by the height of said first pushing element.

20. A container in accordance with claim 16, wherein at least one of said pushing elements is equipped with knives, which cut the bulk material during the motion of said pushing element.
